(19) United States
(12) Patent Application Publication
(10) Pub. No.: US 2004/0112120 A1
(43) Pub. Date: Jun. 17, 2004

(54) System and method for releasing ethylene gas to botanical systems

(76) Inventors: Fritz Kramer, South Houston, TX (US); G. Graham Allan, Kenmore, WA (US)

Correspondence Address: STRADLING YOCCO CARLSON & RAUTH, SUITE 1600, 660 NEWPORT CENTER DRIVE, P.O. BOX 7680, NEWPORT BEACH, CA, 92660, US

(21) Appl. No.: 10/645,166

(22) Filed: Aug. 20, 2003

Related U.S. Application Data
(60) Provisional application No. 60/404,849, filed on Aug. 21, 2002.

(51) Int. Cl. G01N 11/00

(52) U.S. Cl. 73/53.01

(57) ABSTRACT

A composition capable of supplying ethylene gas to botanical systems is disclosed and includes a microporous solid having a plurality of cells and a quantity of ethylene gas contained within one or more of the plurality of cells. The cells can be either open or closed, and can be either permeable, degradable or both so as to release the ethylene over a period of time. The ethylene gas is released from the cells over a period of time. The release rate of the ethylene gas may be altered by changing the density of the microporous solid. The release rate may also be altered by manipulating the size or shape of the microporous solid.

### BACKGROUND

The present application discloses various embodiments of systems and methods for supplying ethylene gas from petrochemical sources directly to botanical systems. More specifically, embodiments of the present application relate to a composition and a method for slowly releasing contained ethylene gas to the surrounding environment over an adjustable prolonged period of time so that the liberated ethylene can interact with seeds or plants as a growth regulator to secure beneficial effects.

Ethylene gas is one of a group of chemicals called plant growth regulators. As far back as 1864 Girardin observed that leaking illuminating gas could affect plants by promoting leaf abscission. Subsequently, extensive literature has been developed that shows ethylene has an impact on various parts of the life cycle of plants such as germination, growth, ripening, senescence and abscission.

Although some of the group of known plant growth regulators have been commercialized in agriculture, ethylene has presented some special application problems. Since ethylene is a gas under ambient conditions, it is extremely difficult, if not impossible, to use ethylene gas under field conditions (Bebawi et al. 1985 Lurssen, 1978). For example, the gaseous nature of ethylene makes it difficult to introduce it into the soil. Even when ethylene is mechanically injected into the soil (Bebawi & Eplee 1986; Bebawi et al. 1985; Eplee, 1975) it can escape to the atmosphere above relatively quickly, although some absorption onto the soil may occur (Witt & Weber 1975). Therefore, depending on the wind and weather, the duration of the effect of ethylene gas may be quite short and plants may not be contacted and affected by the ethylene during that brief period.

To circumvent these difficulties the current approach for utilizing ethylene as a growth regulator has been to synthesize a solid chemical compound which when used in a water solution can be sprayed onto plants where it then decomposes into ethylene. For example, 2-chloroethanephosphonic acid, is an ethylene derivative and represents one version of a commercialized product based upon the above-described approach. Currently, 2-chloroethanephosphonic acid (which is sold under the trade name Ethephon) is widely used in the cultivation of pineapples and cotton. However, the chemical synthesis of an ethylene derivative capable of regenerating ethylene under field conditions is a complicated and circuitous way of solving a problem. Additionally, this approach is also costly.

Other, even more exotic and expensive precursors of ethylene have been synthesized and tested. These include the amino acid, 1-aminocyclopropane carboxylic acid, which decomposes in the plant to yield ethylene (Mohamed et al. 2001).

In contrast, ethylene itself is abundantly available from the petrochemical industry at a modest cost. Clearly, it would be more desirable to find a way of delivering the ethylene gas from the petrochemical sources directly to plants, seeds, soil, vegetation and other agricultural components.

Efforts to do this have been reported in scientific literature. The solutions proposed have involved injecting ethylene gas, from a pressurized metal cylinder carried on the back of an applicator, into the soil. Obviously this is impractical for commercial scale agriculture for a whole host of reasons. Another proposed solution suggests distributing ethylene through the soil of a field by a network of buried piping. Again this would be impractical because of the cost of the piping, its installation and maintenance.

A more promising approach, now under evaluation, contemplates the growth of bacteria capable of producing ethylene in the soil. When additional studies on the pathogenicity and bacterial ecology of these organisms have been completed it may be possible to use them as a source of ethylene in the soil (D. K. Berner, N. W. Schaad and B. Volksch, U.S.D.A. Agricultural Research Service, http://www.nat.usda.gov/ttic/tektran, 1999-08-13). However, the development of a practical system based on such bacteria lies many years in the future. The very existence of this work within the U.S. Department of Agriculture demonstrates the need for a longer-acting ethylene delivery system.

What agriculture needs is a new solid form of ethylene which can be incorporated into botanical systems with standard agricultural equipment and which will release ethylene slowly over a sufficiently long period of time so that components of the botanical systems will be affected by the presence of the ethylene gas.

### SUMMARY

The present application discloses a composition and method capable of supplying ethylene as a gas to botanical systems over an adjustable prolonged period of time. Further, the ethylene can be incorporated into the botanical system so that growing plants and other components of the botanical system will be affected by the presence of the ethylene gas.

In one embodiment, the composition capable of supplying ethylene gas to botanical systems comprises a microporous solid having a plurality of cells and a quantity of ethylene gas contained within one or more of the plurality of cells. The cells can be either open or closed, and can be either permeable, degradable or both so as to release the ethylene over a period of time. The ethylene gas is released from the cells over a period of time. The release rate of the ethylene gas may be altered by changing the density of the microporous solid. The release rate may also be altered by manipulating the size or shape of the microporous solid.

In alternate embodiments the microporous solid may be a polymeric foam, an aminoplast foam, a nitrogenous microporous solid, or a crosslinked urea-formaldehyde insulation foam. Alternatively the microporous is not required to be any of the afore listed examples and may instead by another type of microporous solid.

Additional embodiments provide a method for controlling the release of ethylene gas onto botanical systems. In one embodiment, a method includes preparing a microporous composition having one or more cells containing ethylene gas. The prepared microporous composition is applied to a botanical system. The microporous composition may be applied by numerous methods which include, but are not limited to, spraying the composition directly onto plants, trees or a ground surface, inserting the microporous composition into the ground and placing the microporous composition into a container and suspending the container adjacent a botanical system so as to provide ethylene gas to the botanical system.

Ethylene gas may be released from the microporous composition by diffusing out of a cell in which the gas is contained. Also, some cells may have walls which are configured to crack or degrade over time, such as by biodegradation, thereby allowing the ethylene gas to be released through the open cracks or degraded cell walls. The microporous solution may be placed in a mostly non-permeable container for transport from the point of manufacture.

### BRIEF DESCRIPTION OF THE DRAWINGS

FIG. 1 is a schematic diagram illustrating a foam-producing system.

FIG. 2 is a conceptual drawing showing a foam heap for determining setting time.

FIG. 3 is a conceptual drawing of a microscopic portion a microporous composition.

### DETAILED DESCRIPTION

Embodiments disclosed in the present application provide a series of new simple, safe and effective microporous compositions and methods capable of providing the controlled release of ethylene to botanical systems. The term botanical systems includes, but is not limited to such items as plants, seeds, soil, crops, vegetation and other plant-related agricultural components. The term petrochemical refers to chemicals isolated or derived from petroleum or natural gas. A microporous composition can include any composition which permits reversible or releasable retention of a fluid within cells within the composition. A fluid can be a gas or a liquid.

Embodiments of microporous compositions may be effectively utilized under practical agricultural conditions to release ethylene gas in a controlled fashion. In principle many microporous compositions can be made and filled with ethylene gas. For example, compositions based on foamed aminoplast resins, particularly urea-formaldehyde resins, may be utilized.

Using aminoplast resins is advantageous since basic aminoplast resins are already produced in large commercial quantities for a whole host of applications including the coating of urea fertilizers for agriculture. Most lawn fertilizers sold in the U.S. also contain aminoplast resins as a source of long acting nitrogen. Thus, the acceptability of aminoplast resins in soil is firmly established.

Furthermore, the technology for converting the aminoplast resins into air filled foams is well established commercially. In this technology a blend of the aminoplast resin in water and an acidic catalyst containing a surfactant also in water is vigorous admixed with air. The foam formed hardens to a microporous solid within a few minutes. This hardened foam can have a density of as little as 1 lb. per cubic foot. The empty spaces within the foam are also referred to as cells or microvoids. The cells of the above described foam contain air. About 60% of the cells are closed and the remainder open cells.

During research and experimentation for development of ethylene-releasing systems, it was discovered that the air used to create the foam is unnecessary and can be replaced with commercial ethylene gas. The hardened foam then contains ethylene gas instead of the oxygen and nitrogen gases of the air. When this hardened foam containing ethylene gas is placed in soil, the ethylene gas therein will slowly escape to contact seeds or plants in the vicinity. The rate of release of the ethylene gas can be adjusted by the size and shape of the container foam and by manipulation of the density of the foam.

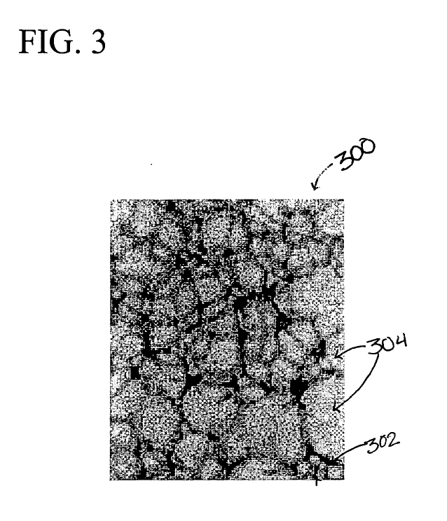

The above described hardened foam containing ethylene gas is illustrated in FIG. 3. Referring to FIG. 3, a hardened foam 300 is made of a foam 302 and multiple cells 304 which contain ethylene gas. The ethylene gas may be diffused through a wall of the cell 304 in which the gas is contained or the ethylene gas may be released at a later point in time when the wall of the cell degrades and becomes porous. To control the rate of diffusion the density of the foam may be manipulated by altering the number of cells in the foam. Additionally, the size of the hardened foam 300 may also be altered to control the rate of diffusion of the ethylene gas from the cell. The cells 304 may have either an opened or closed cell configuration (not shown). A cell is a contained or hollow unit in a structure. Cells can include but are not limited to compartments, cavities, microvoids, and bubbles. A cell can be almost any unit that is both capable of containing ethylene gas and able to release any ethylene gas contained therein.

The following example is provided to illustrate one embodiment of an ethylene releasing foam. For purposes of this illustration an aminoplast resin is used to make the foam. A suitable aminoplast resin comprises urea-formaldehyde reaction product in about 2:1 formaldehyde:urea mole ratio dissolved in water. When prepared for application, the resin should comprise about 30% solids and have a cloud point in a range of about 15 to about 20. The catalyst/surfactant is anionic phosphoric acid mixed with hydroquinone. For this example, hydroquinone was used rather than the conventionally utilized resourcinol, since hydroquinone does not have resorcinol's tendency to color the solution red. Hydroquinone, resourcinol or any other compatible material may also be utilized. Referring back to the example preparation of the foam, the foaming agent is provided in concentrate form and is diluted with water to about the volume of resin. Typically, the dilution ratio is about 25:1, but necessarily depends on the initial concentration of the foaming agent. Further, the concentration (volume) of phosphoric acid is adjusted to exhibit a pH in the range of about 7.2 to about 7.4 in the cooled foam.

The resin and foaming agent are combined in a foam applicator, to be described in greater detail below, and vigorously mixed with ethylene gas under pressure. The foam applicator operates more or less in a conventional fashion to combine the resin with the catalyst in a mixing nozzle and produce a foam current which extrudes from the nozzle. The density of the foam may be manipulated by adjusting the gas pressure. Increasing or decreasing the gas pressure, while holding the introduction rate of resin and catalyst constant, adds more or less gas, respectively, to the foam current resulting in a lower or higher density, respectively, of the end product.

In one particular aspect, and only by way of example, an initial volume of about 55 gallons of resin and an equal volume of catalyst/surfactant will, when mixed with ethylene gas at about 60-100 psi, produce a volume of about 300 cubic feet of foam, weighing about 675 pounds, and thereby having a density of about 2.25 pounds per cubic foot. As formed, the foam will comprise about 1 million cells (microvoids) per liter, wherein the cells are filled with ethylene gas. Gas entrapment occurs as the gas forms microbubbles (cells) from the foaming agent to produce a foam having the consistency of shaving cream. Microbubbles may be coated with resin in a separate chamber, and the catalyst hardens the resin shell about the cells.

Gas transport can occur through cracked cell walls as well as by conventional diffusion. Further, it should be noted that certain forms of bacteria, normally found in soil, act to breakdown aminoplast foams, thereby allowing the release of gas from interior cells. This bacteria induced breakdown also allows the material to decompose naturally in the soil. Diffusion proceeds until the supply of ethylene gas is exhausted. Another application of gas-containing foam is then required to apply additional ethylene to the soil. It is important to note that application of the gas-containing foam is not limited to the soil. The gas-containing foam may also be applied directly onto plants or vegetation, or be applied by any of numerous number of methods which enable released ethylene gas to contact a botanical system.

A better understanding of embodiments of an ethylene releasing foam may be had with reference to the following example. One typical commercial aminoplast resin suitable for providing ethylene releasing systems might be a resin similar to those used in making foamed-in-place insulation. One such resin is Thermco resin manufactured by the Thermal Corp. of America, 1405 West Washington St., Mt. Pleasant, Iowa 52641. One combination of catalyst and foaming agent which might be used in conjunction with the aminoplast resin is Thermo Foaming Agent of the same company. These two ingredients, the resin and the foaming agent/hardener are combined in a mixing gun.

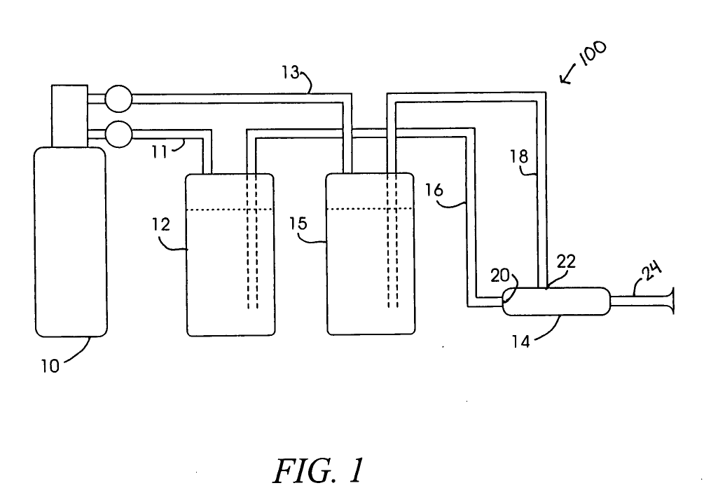

The liquid components may be used with equipment capable of delivering ten parts resin per nine parts foaming agent, as will be described in connection with the exemplary embodiment of FIG. 1. In FIG. 1, the foam-producing apparatus 100 is operated by a compressed ethylene gas provided in a gas cylinder 10. A pressure regulated gas conduit 11 conducts pressure regulated ethylene gas to a foaming chamber 12 containing the foaming agent/catalyst solution. Gas is introduced to the chamber 12 where it produces a foam, which is subsequently directed to a mixing chamber 14 (also termed a foaming gun). The mixing chamber 14 is also coupled to a resin chamber 15 by a resin conduit 18. Resin chamber 15 provides a source of pressure regulated resin. The produced foam and resin combined in the mixing chamber 14 is released through a foam application hose 24.

The amounts of foam and resin combined in the mixing chamber 14 is controlled by foam and resin introduction orifices 20 and 22 respectively, as well as foam and resin pressures. Pressure at the mixing chamber 14 should be in the range of about 58 to about 85 psi with not more than 10 per cent difference in pressure between the foaming agent and resin sides. In order to produce a foam having an appropriate consistency and density, the orifice sizes of the mixing chamber 14 should be about 0.2 mm for the resin orifice 22 and about 1.5 mm for the foaming agent orifice 20. Further, the resin and foaming agent should both be at a temperature of from about 55° F. to about 85° F. when they reach the mixing chamber 14. The finished foamed plastic which is released through foam application hose 24 is generally a fluffy white material with a generally warty surface. Fresh foam should weigh 36 to 44 g per liter, or about 2.25 to about 2.75 pcf.

Using this technique, the foam may be generated in a continuous stream of gas, foaming agent and foaming resin. For example, the ethylene gas “foams-up” the foaming agent in the foaming cylinder 12. The resulting foam is directed to the mixing chamber 14 and the resin from resin chamber 15 is then injected in the mixing chamber 14. The mixing and expansion is complete after the foam travels through a foam application hose 24, which has a length, typically, of about 75″ (180 cm). The mixture is then pushed through the hose and disposed into various containers, such as cans, hoses, boxes, tubes, and the like, for storage and shipping.

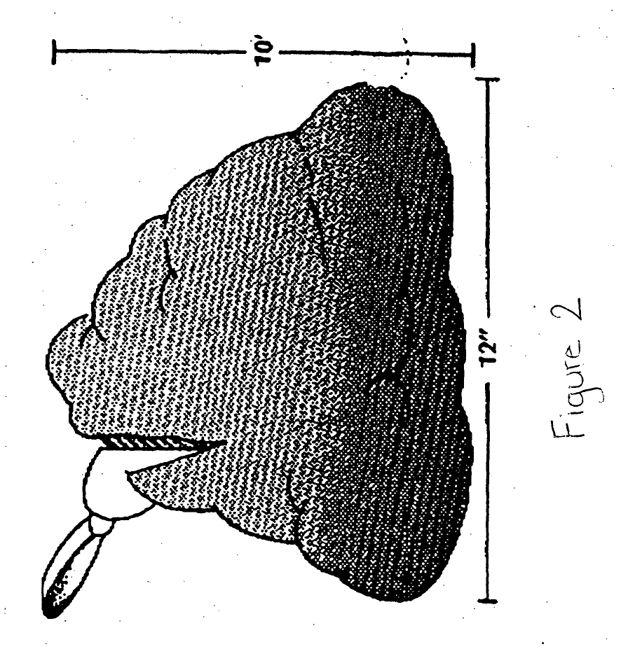

Setting time and density are indicators of the quality of the foam. For example with regards to setting time, the foam should set in no less than 5 seconds and no more than 60 seconds after it leaves the foam application hose 24. Setting time is established by foaming a foam heap which is then trowelled with a small spatula until it can no longer be trowelled. At that point it must break, when the spatula is inserted and pulled across, with a clean smooth surface. The time interval between foaming and breaking is the setting time. A foam heap established by foaming is illustrated in FIG. 2. A small spatula 22 is used to trowel the foam heap 20. A useful density for one embodiment is achieved when one cube of fresh foam measuring 4″×4″×4″ (one liter) weighs no less than 1.3 ounces and no more than 1.5 ounces (36-44 grams).

In order to prevent premature dissipation of contained ethylene gas from the finished foam, it may be useful to package the foam in a material that is impervious to ethylene diffusion therethrough. One suitable material is aluminum foil. Once the foam is packaged, or wrapped, in a generally gas impervious material, a pressure differential diffusion mechanism no longer obtains for the ethylene gas, and the ethylene concentration is maintained at substantially its initial level in the fresh foam.

Application of the finished foam product may be accomplished in a number of ways. Additionally, the introduction of the finished foam product into a botanical system can be accomplished in the same manner as the introduction of other solid fertilizers. The finished foam product may be applied by spraying the foam directly onto the intended surface such as plants, trees, berries, soil surface or the like. Additionally, the finished foam product may also be applied by spraying the foam directly into the soil. In yet another application, the finished foam product may be placed in a permeable container wherein the container is suspended adjacent a target botanical system to allow the released ethylene gas to affect nearby targets. Specifically, to further illustrate this application, finished foam may be placed in a milk carton container and suspended from a tree branch. Once the ethylene gas has left the foam and the milk carton, the ethylene gas would be able to affect leaves or berries on a tree. This is only one example of a suspending application method of the ethylene emitting foam. Any suitable type of container could be used to contain the foam. The permeability of the container can be an important factor in controlling the effectiveness of the ethylene gas.

Regardless of how the finished foam or other ethylene emitting composition is applied, it has been determined, by suitable experimentation, that ethylene gas is released, in sufficient concentrations to exhibit beneficial botanical effects, for periods up to 20 days, and not less than 9 days. Characteristically, the ethylene introduction rate can be manipulated by manipulating the density of the foam, with higher density foam necessarily moderating ethylene diffusion.

Additionally, many types of materials may be used in making an embodiment of a microporous solid of an ethylene releasing foam. For example, a microporous solid having geometrically positioned cells may be a useful material. The geometrically positioned cells would contain the ethylene gas. One example of a solid having polymeric materials layered to create cells or bubbles between the layers is the well-known bubble wrap. In conventional bubble wrap materials, bubbles are formed between multiple layers of a polymeric sheets. The bubbles are essentially cells containing air. In an embodiment, the bubbles formed would be cells filled with ethylene gas rather than air. The layers of polymeric sheets could be a microporous material permeable to the ethylene gas in the bubble cells. Alternatively, the polymeric sheets could be made of a degradable material. As such, the bubble walls can degrade over time and release the ethylene gas contained within the cells or bubbles. The ethylene gas would be released by diffusion from the cells to some type of vegetation or plant.

Those skilled in the art will further appreciate that the ethylene releasing material may be embodied in other specific forms without departing from the spirit or central attributes thereof. In that the foregoing description discloses only exemplary embodiments thereof, it is to be understood that other variations are contemplated as being within the scope of the present invention. Accordingly, the present invention is not limited in the particular embodiments which have been described in detail therein. Rather, reference should be made to the appended claims as indicative of the scope and content of the present invention.

We claim:

1. A composition of matter comprising a microporous solid having a plurality of cells and a quantity of ethylene gas contained within one or more of the plurality of cells.

2. The composition of matter of claim 1 wherein one or more than one of the plurality of cells is an open cell.

3. The composition of matter of claim 1 wherein one or more than one of each of the plurality of cells has a closed cell configuration.

4. The composition of matter of claim 1 wherein the microporous solid is a crosslinked aminoplast foam.

5. The composition of matter of claim 1 wherein the microporous solid has a density of between 0.1 to 10 lb./cubic foot.

6. The composition of matter of claim 1 wherein the microporous solid is a nitrogenous microporous solid.

7. The composition of matter of claim 1 wherein the ethylene gas is able to be released from the cell over a period of time.

8. The composition of matter of claim 1 wherein the ethylene gas is able to be released from the cell by diffusion through a wall of the cells.

9. The composition of matter of claim 1 wherein the ethylene gas is able to be released by degradation of a wall of the cell.

10. The composition of matter of claim 9 wherein the wall of the cell is configured to degrade by the process of biodegradation.

11. The composition of matter of claim 7 wherein the microporous solid has a density and the density can be altered to change the rate at which ethylene gas is released from the cell.

12. The composition of matter of claim 7 wherein the microporous solid has a shape and the shape of the microporous solid can be manipulated to change the rate at which the ethylene gas is released from the permeable cell.

13. The composition of matter of claim 7 wherein the microporous solid has a size and the size of the microporous solid can be manipulated to change the rate at which the ethylene gas is released from the permeable cell.

14. The composition of matter of claim 1 wherein the microporous solid is a typical crosslinked urea-formaldehyde insulation foam.

15. A method for releasing ethylene gas into a botanical system, comprising:
providing a microporous composition comprising one or more cells containing ethylene gas therein;
applying the microporous composition to the botanical system; and
releasing the ethylene gas from the microporous composition onto the botanical system.

16. The method of claim 15 wherein providing a microporous composition further comprises preparing a microporous composition.

17. The method of claim 15 wherein the botanical system includes soil and in the applying step, the microporous composition is applied directly onto the soil.

18. The method of claim 15 wherein the botanical system includes soil and the microporous composition is applied into the soil.

19. The method of claim 15 wherein the botanical system comprises at least one tree having a branch, and the microporous composition is applied by suspending the microporous composition from the branch.

20. The method of claim 15 wherein the botanical system comprises at least one plant, and the microporous composition is applied directly onto the plant.

21. The method of claim 15 wherein the ethylene gas is released from the microporous composition by diffusing through the one or more cells.

22. The method of claim 21, wherein the ethylene diffuses from the microporous composition at a determined release rate.

23. The method of claim 22, wherein the release rate of the microporous composition is altered by changing the size of the microporous composition.

24. The method of claim 22 wherein the release rate of the microporous composition is altered by changing the shape of the microporous composition.

25. The method of claim 22 wherein the release rate of the microporous composition is altered by changing the density of the microporous composition.

26. The method of claim 26 wherein the prepared microporous composition is a microporous foam formed by combining ethylene gas with a foaming agent to form an intermediate composition, and mixing a resin to the intermediate composition foam.

27. A method of releasing ethylene gas from petrochemical sources directly to a botanical system comprising:
means for providing a microporous composition comprising one or more than one cell and a quantity of ethylene gas in one or more than one cell;
means for introducing the microporous composition into a botanical system; and
means for diffusing the quantity of ethylene gas from the microporous composition into the botanical system.
